(19) United States
(12) Patent Application Publication
(10) Pub. No.: US 2003/0073556 A1
(43) Pub. Date: Apr. 17, 2003

(54) Kit and method for making boxes

(76) Inventor: Martin R. Carbone, Santa Barbara, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/301,111

(22) Filed: Nov. 20, 2002

Related U.S. Application Data
(62) Division of application No. 09/487,510, filed on Jan. 19, 2000.
(60) Provisional application No. 60/116,725, filed on Jan. 20, 1999.

(51) Int. Cl. B31B 1/25

(52) U.S. Cl. 493/160

(57) ABSTRACT

A device, method, and special sheet material for making boxes out of solid cardstock, corrugated cardstock, and other sheet materials of various thicknesses. The device is for use with conventional or specialized box making sheet materials and includes a scoring plate with at least one elongate groove therein. The elongate groove has two sharp inner edges where the groove is formed in the scoring plate. A scoring tool that has a working end that is wider than the scoring groove is also provided. The special sheet material has a printed thereon a grid pattern of double or triple marks. Alternately, the sheet material is provided with a grid pattern of pre-scored parallel line sets. The box materials is cut and folded on selected lines of the line sets.

### CROSS-REFERENCE TO RELATED APPLICATION

This application is a divisional patent application of pending U.S. patent application Ser. No. 09/487,510 filed on Jan. 19, 2000, which is based upon provisional patent application serial No. 60/116,725, filed Jan. 20, 1999.

### BACKGROUND OF THE INVENTION

1. Field of the Invention

This invention relates to the field of box making, particularly to the field of making custom sized boxes, and more particularly to custom sized telescoping boxes.

2. Description of Related Arts

Boxes are used to ship and store many different items. Pre-made boxes formed of a variety of materials, e.g. corrugated cardboard, card stock, and similar and comparable materials, come in a wide range of sizes and shapes (e.g. a box measuring 15 cm×15 cm×15 cm, made of single ply corrugated cardboard.) Although there are a wide variety of pre-made boxes available, the fact remains that there are almost an infinite number of size and material combinations possible and useful. Moreover, very often, a user wishes to create custom boxes having particular dimensions and materials, or the user needs relatively small runs of boxes of particular sizes and materials, and therefore does not wish to order a large number of pre-made boxes.

Double Boxing

It is a well-known fact that one of the most efficient ways to ship damageable goods is to double box it, that is to place the goods in a first, closely conforming inner box, and then place the first, object containing inner box, into a loose fitting outer box, with the space between the inner and outer boxes filled with low density, shock absorbing material. Ideally, the inner spacing between the inner and outer boxes can be optimized to provide just enough space for low-density fill material, but not too much so that the outer box is of excessively large dimension. In these double boxing applications, it would be particular helpful to be able to have perfectly sized boxes, since doing so will reduce the amount of box material and packing material, and will reduce the size and weight of the box. Moreover, because a variety of pre-made box styles will no longer be necessary, storage space and money can be saved.

Previous Scoring and Folding Methods

Manual and mechanized sheet scoring systems have either used (1) a scoring tool and a relatively wide scoring slot whereby the material to be scored is pressed into the slot by the scoring tool; or (2) a scoring tool without a scoring slot whereby the scoring tool is used to press the cardstock against a flat, somewhat resilient surface, weakening the cardstock on the line traversed by the tool. In both of these methods noted above, the cardstock is folded along the single line made by the scoring tool. In general, flat cardstock of any thickness to about 0.1016 cm (0.040 inch) can be scored by machine or by hand. These scoring methods have at least three disadvantages:

first, the cardstock can only be folded on the single line made by the scoring tool;

second, if the cardstock is thin or weak, the scoring tool can break through the cardstock into the scoring slot and tear the cardstock; and

third, tools are needed for measurement and for placing the score in the proper positions on the top and bottom of the box material.

Thicker flat cardstock and corrugated cardstock is usually scored by machine and not by a hand-drawn scoring tool.

Corrugated cardstock can and has, in the past, been crush-folded over a sharp and rigid square table edge and does not have to be scored prior to folding. However, for hand made boxes, it has not been easy to precisely determine where to cut and fold the corrugated cardstock. Rather complex calculations have had to be made and measurements have had to be done and lines have had to be drawn in accordance with those calculations in order to make a box of the desired dimensions.

Making Telescoping Boxes

Prior boxes with tops and bottoms that fit together in a telescoping manner have been made by scoring, cutting, folding, gluing and assembling two pieces of cardstock (one piece for the bottom of the box and one piece for the top of the box) together. This procedure can be done automatically by machines which must be carefully set up to yield the box size desired, or by hand, with the use of hand tools and measuring instruments whereby the craftsperson prepares the proper size cardstock and the position of the scores, cuts and folds for the top and bottom, or with the kits invented by the inventor and shown in U.S. Pat. Nos. 5,484,373, 5,707,327 and 5,855,543. The inventor's prior kits provide a method for making such boxes through the use of preset vertical locating edges, which yield one set of scoring, cutting and folding marks for the top and another set of scoring, cutting and folding marks for the bottom of the box being made.

These above noted box making methods suffer from certain disadvantages; (a) measuring tools are needed for methods preceding the patents referenced immediately above, (b) different marked patterns are needed for the cutting, scoring and folding of the top and bottom of each box, and (c) in the kit of U.S. Pat. No. 5,484,373, different size cardstock is required for the box tops and bottoms.

### SUMMARY OF THE INVENTION

The invention provides a method of making cardstock boxes—both corrugated and not corrugated, as well as other sheet materials, by using a system of marking, by printing, scoring, perforating or any other method of delineating two or three line sets of cutting and folding lines, whereby such line sets allow the user to design and fabricate telescoping boxes and other box types where the fold lines of the box must be adjusted some small amount to permit nesting fits and clearances for the box elements (sides, ends, flaps, tops and bottoms) of the box.

The scoring and/or printing and/or any other method of delineating cutting and folding lines each serve the same purpose, namely to put sets of two or three marked lines on the cardstock or corrugated cardboard; those line sets serving as guide lines for folding and/or cutting the sheet material to make boxes having the desired dimensions and characteristics.

Scoring Method

With the scoring method of marking, no table edge or other sharp edge is required.

Boxes can be with scored cardstock sheets using a cutting means (e.g. a razor knife or scissors) and some attachments means (e.g. adhesives, tape, staples, etc.) The cardstock for use in the scoring method can be provided to the user in a pre-scored form, or the user can score the sheet material himself or herself.

A first embodiment of the invention is a device for forming dual score lines in sheets of unscored sheet material. The device comprises a scoring plate with at least one elongate groove therein and a scoring tool. The elongate groove has two sharp inner edges where the groove is formed in the scoring plate. The scoring tool has a working end that is wider than the scoring groove. The sheet material to be scored is first placed on top of the scoring plate with the area of the line to be scored placed over the scoring groove. The scoring tool is then pressed down on the material along the scoring groove which forces the material onto the two sharp edges to create two parallel crease lines on the sheet material. These dual crease lines are used for folding or as guide lines for cutting the sheet material, as will be described below.

As noted above, the sheet material can be provided to the user in a pre-scored form, with the cardstock (e.g. 0.051 inch [0.02 cm] thick) having a grid pattern of scored lines (e.g. in 2.54 cm [1 inch]) intervals. Each score has two indented ridges at the longitudinal edges of the scores.

The two indented ridges of each score line are spaced a precise distance apart and provide, in effect, a set of dual score lines.

The scored cardstock can be folded on either of the two parallel crease lines or two selected indented ridges, yielding nesting trays of two slightly different sizes. A user can then easily fold up box tops and box bottoms that telescope into each other.

Making a Basic Telescoping Box

A telescoping box can be made in six easy steps from scored sheet material:

1. Decide on the desired box size-length (L), width (W) and depth (D).

2. Determine the size of the cardstock blank needed—(rectangular box are generally made from rectangular blanks.

3. Cut the cardstock blank to size if necessary. The cardstock blanks should be sized to L+2D for finished box length L and W+2D for finished box width W. Two cardstock blanks are needed for each telescope box. Both blanks should be exactly the same size.

4. Mark where notches (or slots) will be cut. When using pre-scored sheet material, use the grid pattern as a guide and mark on the appropriate scoring lines. When using user scored sheet material, use the score lines. The notches define the box panels. Mark the ridges (scoring lines) closest to the outside of the sheet for the top of the box. Mark the ridges (scoring lines) closest to the center of the sheet for the bottom of the box.

5. Cut the notches with the notch points at the marked spots. The notches for the top and bottom will be in slightly different positions.

6. Fold up the top and bottom on the marked ridges and affix (e.g. with adhesive, tape, staples, etc. The two halves will fit together exactly.

The Printing Method

With the printed method of marking sheet material, folding/cutting lines are pre-marked, and the user will need to crush-fold the sheet material over a sharp edge on the lines chosen for the desired box.

The invention works with various sheet materials including solid cardstock of about 0.0203 to 0.1016 cm (0.008 inches to 0.04 inches thick) and corrugated cardstock (e.g. cardboard) of various thickness from about 0.0203 to 0.0424 cm.(080 inches to 0.0167 inches), as well as boxes out of other sheet materials such as plastic sheet material.

In the printing method of the invention, special sheet material is provided which has double or triple parallel line sets printed on the sheet material in a grid pattern. By selecting the desired lines and folding and/or cutting the material along these lines, box making materials such as corrugated cardstock can be folded cleanly over a sharp table edge or over other sharp edges to form a crease in the sheet material. Likewise, the grid pattern of lines provides a guide for precisely cutting the sheet material.

Both the scoring and printing methods serve the same purpose, namely to put marks on the cardstock or corrugated cardboard that will serve as guide lines for folding and/or cutting the sheet material to make boxes having the desired dimensions and characteristics. With the scoring lines, no table edge or other sharp edge is necessary. With the printing method, the folding/cutting lines are pre-marked, but the user needs to crease the sheet material over a sharp edge to actually form the crease lines.

### DESCRIPTION OF THE DRAWINGS

FIG. 1 is a perspective view showing the scoring plate and scoring tool of the kit of the invention.

FIG. 2 is an end view showing the interaction of the working head of the scoring tool pushing sheet material into the two sharp edges of the scoring plate.

FIG. 3 is a cross-sectional view showing the shape of a double scored section of cardstock.

FIG. 4 shows a first embodiment of grid marked sheet material of the invention with pairs of relatively widely spaced apart grid lines.

FIG. 5 shows a second embodiment of grid marked sheet material of the invention with pairs of relatively narrowly spaced apart grid lines.

FIG. 6 shows a third embodiment of grid marked sheet material of the invention with sets of triple grid lines.

FIG. 7 shows a fourth embodiment of grid marked sheet material of the invention with sets of triple grid lines and other reference indicia.

FIG. 8 shows a fifth embodiment of grid marked sheet material of the invention with sets of triple grid lines with size indicia.

FIG. 9 is a plan view showing pre-scored sheet material of the invention.

FIG. 10 is a detail showing a portion of the pre-scored sheet material of FIG. 9.

FIG. 11 is a plan view showing pre-scored sheet material of FIG. 9 marked for a larger box top.

FIG. 12 is a plan view showing pre-scored sheet material of FIG. 11 showing the notch marks.

FIG. 13 is a plan view showing pre-scored sheet material of FIG. 11 showing the notches cut out.

FIG. 14 is a plan view showing pre-scored sheet material showing the notches cut out for a smaller box bottom.

### DETAILED DESCRIPTION OF THE INVENTION

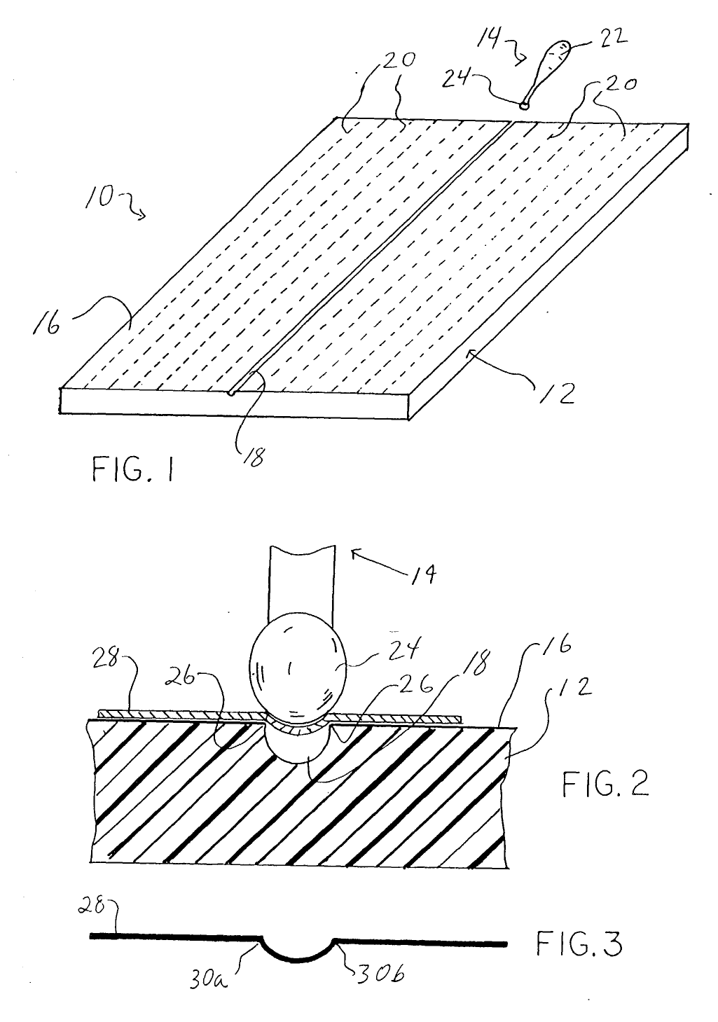

Referring first to FIGS. 1-3, a first embodiment 10 of the invention is shown. Device 10 includes a scoring plate 12 and a scoring tool 14. Scoring plate 12 has an upper surface 16 with an elongate groove or scoring slot 18 formed therein. A plurality of vertical edged locating guides 20 are formed on the upper surface 16 at some predetermined distance from the scoring slot, e.g. 2.54 cm (1 inch) being normally the case. However, other means can be used to retain the edge of the sheet to be scored (e.g. using a single raised wall and providing a plurality of spacing strip, or providing a plurality of elongate grooves in the scoring plate 12) Each of these locating guides 20 may be used to line up the edges of the sheet cardstock, so the scoring is some preset distance from the edges. Scoring tool 14 has a handle portion 22 and a working head 24. Working head 24 is preferably free from sharp edges. As best shown in FIG. 2, working head 24 is wider than elongate groove 18. Elongate groove 18 has two inner edges 26, which edges 26 are preferably relatively sharp.

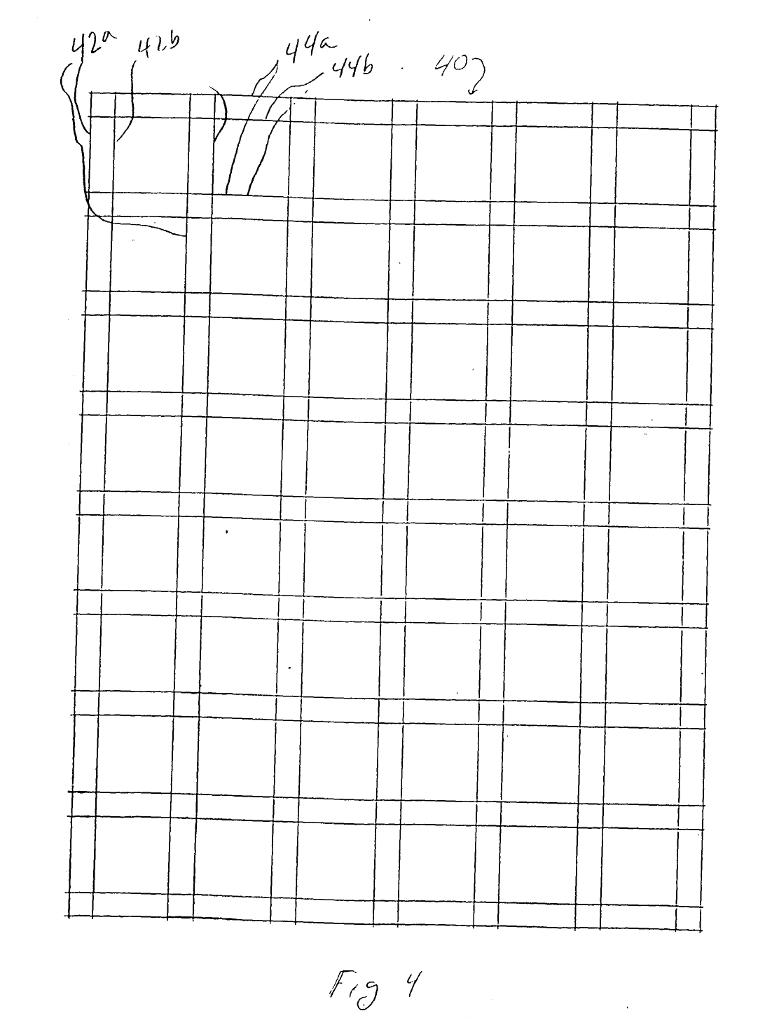

As shown in FIG. 2, to form a two line set of crease lines in sheet material 28, sheet material 28 is laid on upper surface 16 of scoring plate 12, with sheet material 28 aligned such that the areas where the scoring lines are to be made are positioned directly over groove 18. Working head 24 of scoring tool 14 is pressed down on sheet material 28 to cause its underside to contact sharp edges 26 of groove 18, thereby creasing sheet material 28 to form a set of two parallel crease lines 30a and 30b, as shown in FIG. 3. Crease lines 30a and 30b are then available for cutting and folding of the sheet material 28. The plurality of guide markings 20 are located on upper surface 12 of scoring plate 16, and are spaced apart in incremental distances (e.g. in 1 inch increments) from elongate groove 18. By placing an edge of sheet material 28 against one of the guide markings 20, the user can easily locate the position of the two line set of crease lines to be formed in the sheet material 28. Again, working head 24 of scoring tool 14 is significantly wider than elongate groove and does not fully enter elongate groove. Instead of a weakened area centered at the apex of the tool as is accomplished by previous scoring systems, a set of two parallel weakened score lines 30a and 30b are formed.

As an alternative to the groove 18 with its relatively sharp inner edges 26 formed into the scoring plate 12, two parallel spaced apart elongate protrusions can also be formed directly into the scoring plate (not shown.) Likewise, a U-shaped channel (e.g. made of metal) can be retained in the scoring plate with its two ends extending upwardly above the surface of the scoring plate, or two narrow rail sections can be set into and extend above the surface of scoring plate (not shown.) The ends of the U-shaped channel and the two narrow rail sections preferably have relatively narrow and sharp ends. A compressing tool can then be used to push the sheet material down into contact with the two parallel spaced apart elongate protrusions to form the two line set of weakened scoring lines. The compressing tool can be the same as shown in FIGS. 1 and 2.

Device 10 provides for a new method of scoring and making boxes, whereby a single scored results in a two line set of creases that can be cut and folded on either line of the set. This means two pieces of the same size sheet material 28 (such as cardstock) with score sets located in the same place on each piece can be cut, folded and glued (or otherwise attached together) into a box top and a box bottom that fit together in a mating fashion. This new method of double-mark scoring eliminates, in general, the necessity of using slightly different scoring setups for the tops and bottoms of boxes such as are made under the above referenced patents.

The double-mark scoring method eliminates the two different cardstock sizes that are required for use in the kit of U.S. Pat. No. 5,484,373 and the spacing strips used in U.S. Pat. No. 5,707,327 and the necessity for two vertical locating edges as required in U.S. Pat. No. 5,855,543. This new double-mark scoring method also eliminates the necessity for a separate scoring pattern for the manufacture of the tops and bottoms of these types of boxes on certain types of automated scoring equipment whereby the scoring marks are rolled into the cardstock.

The double-mark score essentially has a set of two scoring marks made by a single score. This enables the user to cut and fold the cardstock on either mark. This means that a single score can provide for two different spacings from the edge of sheet material 28. Therefore the cardstock for the top of the box and for the bottom of the box can be scored exactly the same. The difference needed so the top and bottom fit together can be achieved by simply cutting and folding the top on one of the two marks and cutting and folding the bottom on the other mark.

The method of use provide other advantages. First, a set of two precise lines are formed with each scoring stroke. These two lines are separated by a distance corresponding to the width of elongate groove 18. Second, scoring tool 14 cannot tear sheet material 28 because working head's 24 penetration into elongate groove 18 can be precisely controlled by a proper selection of elongate groove 18 width and width and shape of working head 24.

In general, the method works best if edges 26 of elongate groove 18 are sharp edges so they can press into the sheet material and make distinct lines on which sheet material will be cut and folded. However, it would also work to varying degrees if the slot edges were slightly rounded (for weaker types of cardstock) or even with serrated tooth-like projections (for tougher cardstock), neither of which is shown.

There is theoretically no limit to the width of the elongate groove 18. For thin writing paper, the width of the scoring slot may be something in the order of 0.0254 cm (0.010 inch). For thicker cardstock the width of the scoring slot can be 0.254 cm (0.1 inch)

The ratio of the width of the elongate groove to the scoring head thickness will always be less than 1, to prevent the scoring head from pushing the cardstock completely into the groove, but the exact ratio for a particular scoring job will depend on the physical characteristics, such as hardness, ductility and strength of the cardstock and cannot be specified without experimentation for a particular situation. As the ratio approaches 1, the working head 24 of scoring tool 14 will of course advance further into scoring slot 18. In general, a ratio in the order of 0.5 will be satisfactory but in some cases (where it is important that the cardstock not be stressed or deformed) a ratio of 0.1 might be better.

In general the cross section of working head 24 of scoring tool 14 will be circular, but it is anticipated that other shapes such as ellipses, or triangles or irregular shapes may work better for certain specific applications.

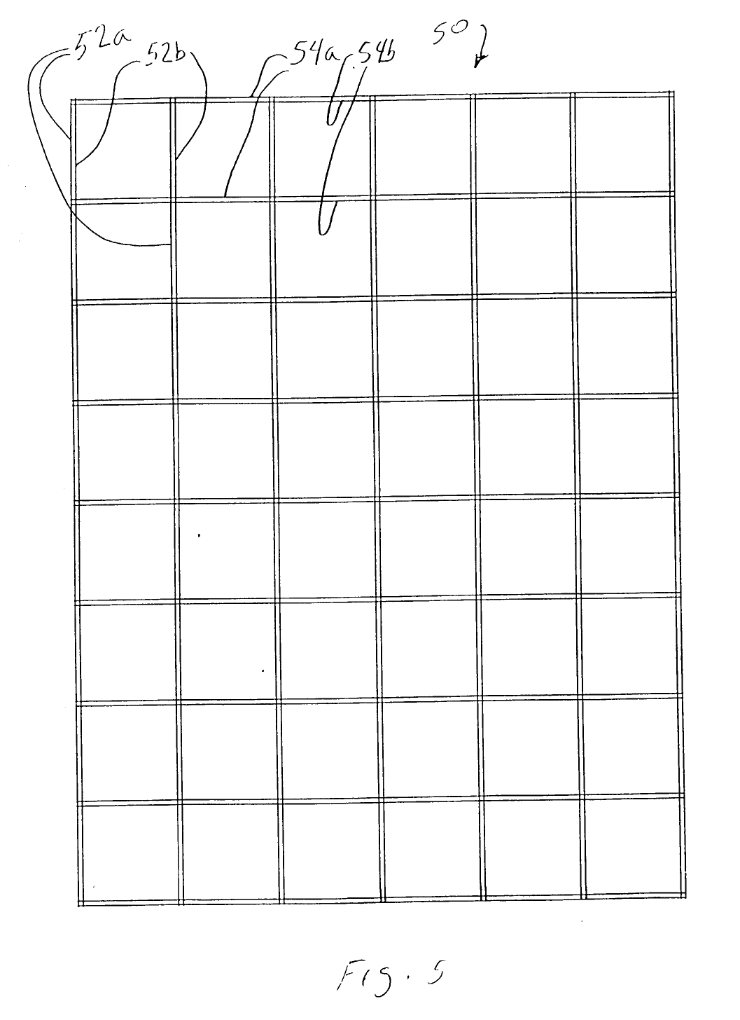

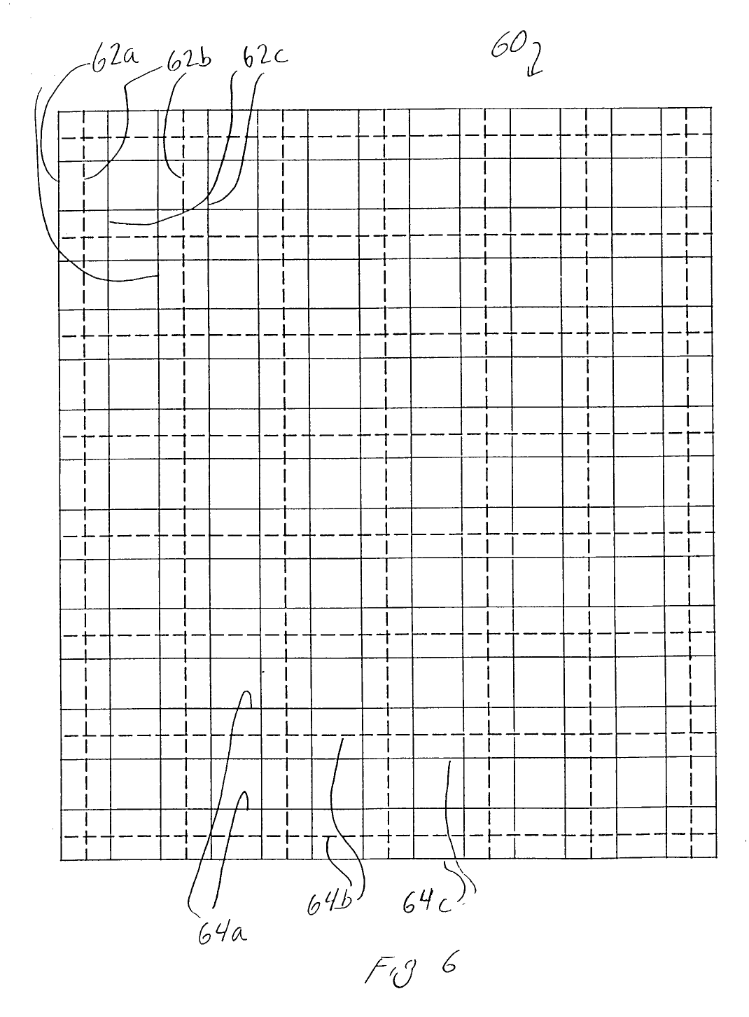

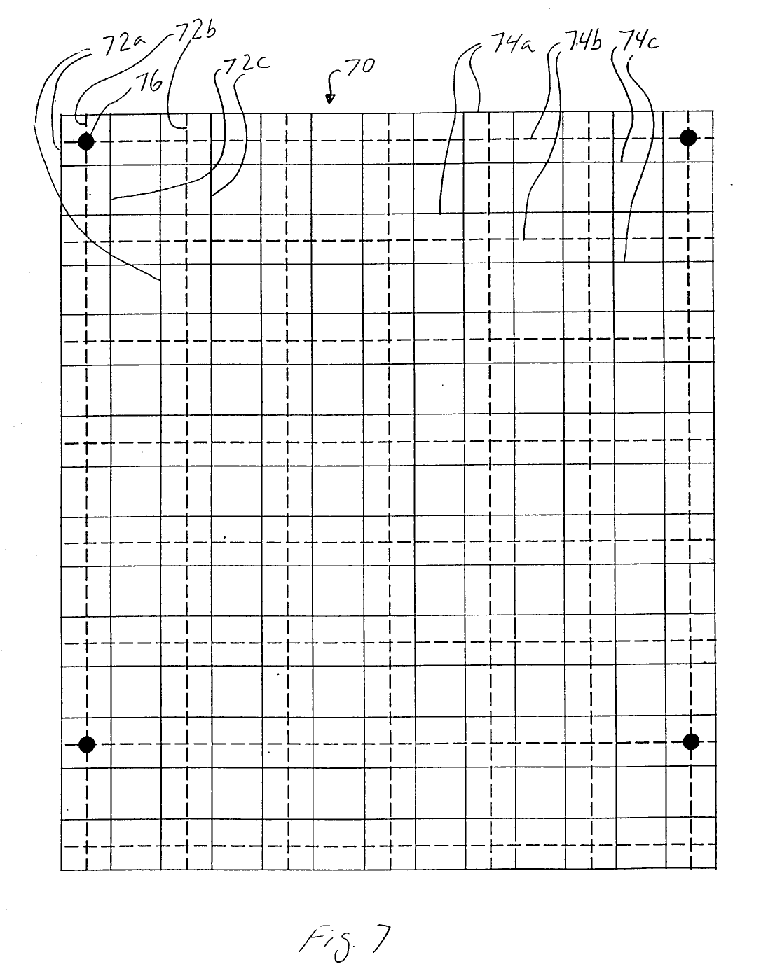

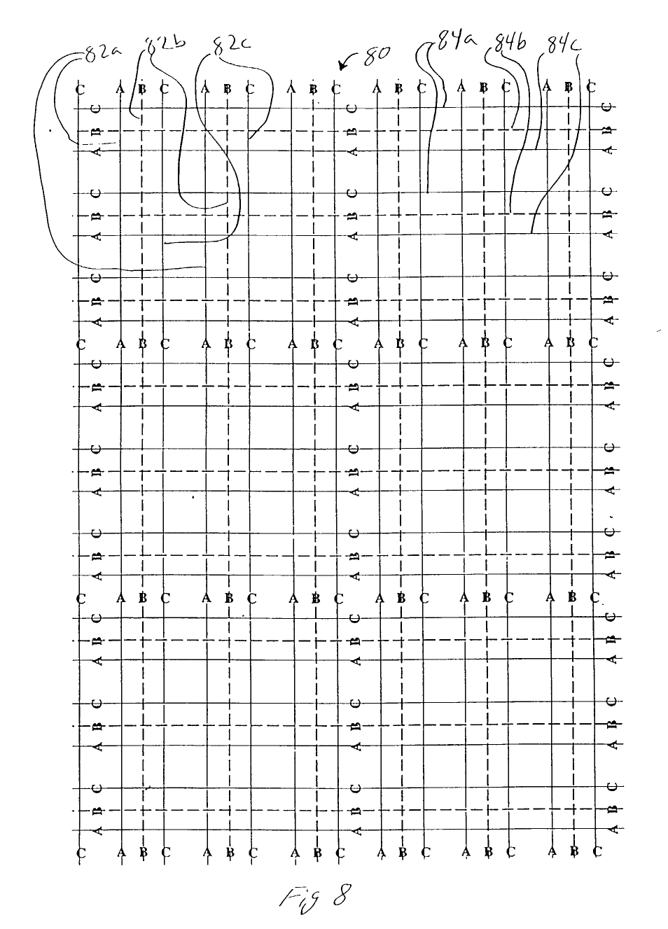

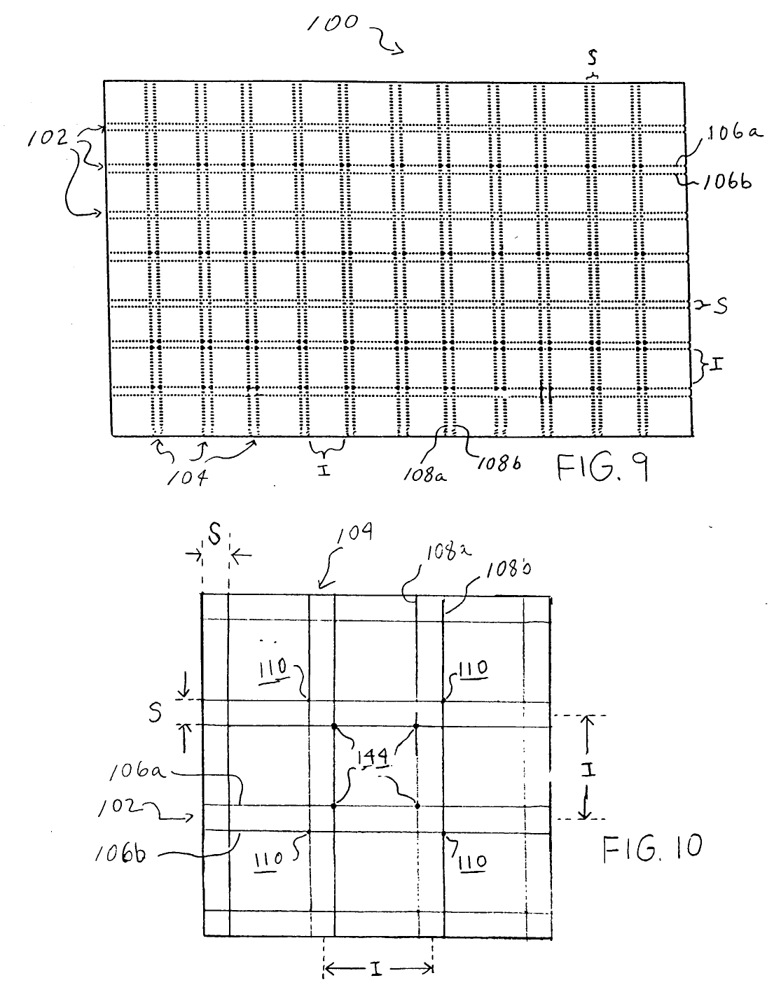

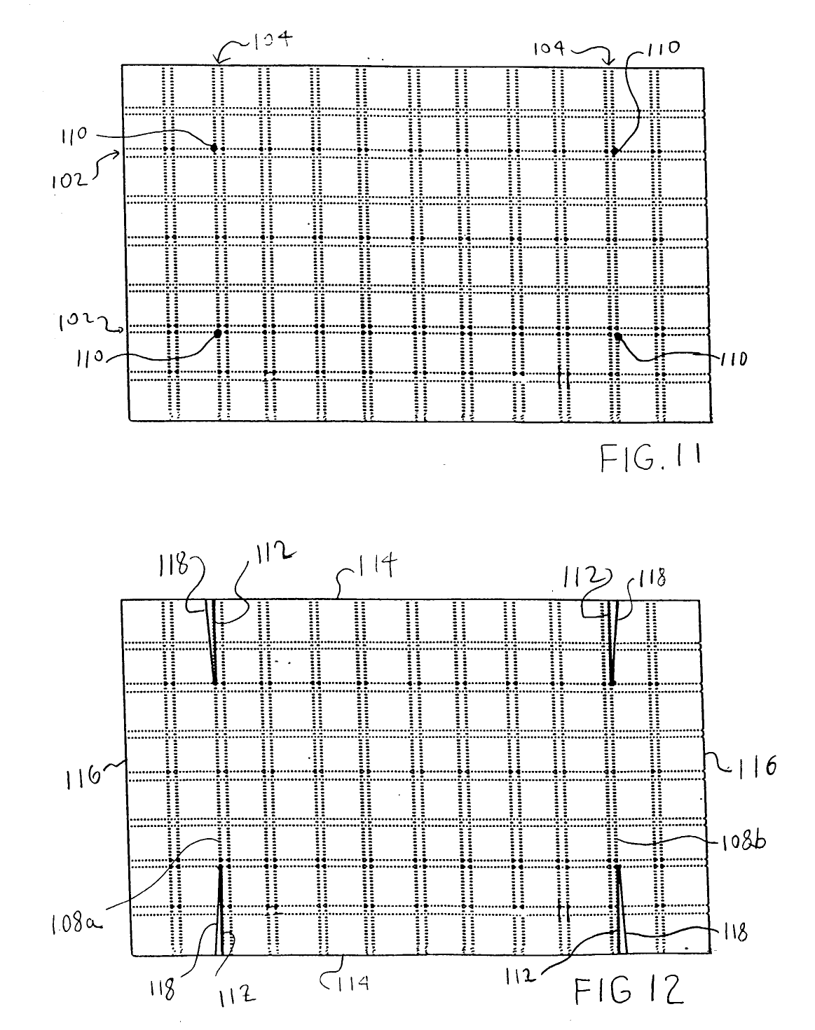

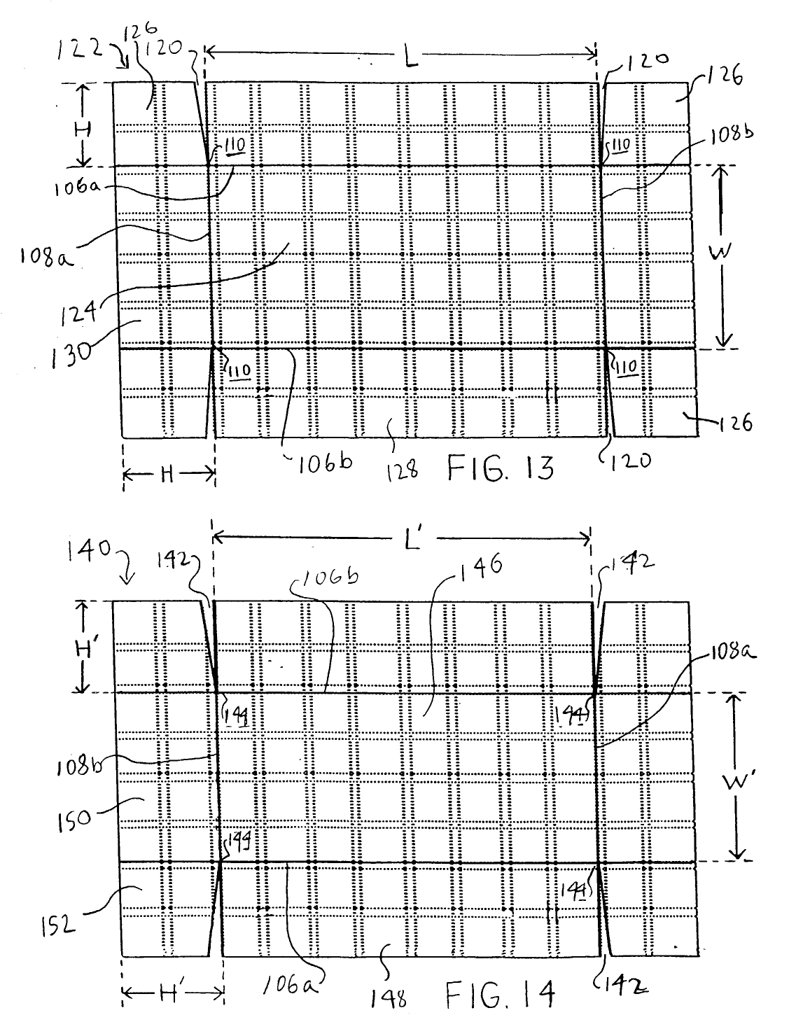

Turning now to FIGS. 4-8, plan views of various embodiments of the marked sheet material for use in box making is shown. In a second method, double or triple parallel line sets are printed on the sheet material in a grid pattern with the sets of lines being parallel and perpendicular on the box making material, such as regular corrugated cardboard which is about ⅛ inch thick and available in the general marketplace in sheets of 3′×6′ and 4′×8′ sizes. In the case of making corrugated cardboard boxes that are nestable and fit together, large sheets of cardboard stock are marked, by printing or otherwise, with a grid pattern of parallel double-line sets, the center of each double line set being evenly spaced in preferably equal increments (e.g. in 1 inch increments) both across the width and length of the sheet. By selecting the desired line and folding and/or cutting the material along these lines, box making materials, such as corrugated cardstock can be cut and folded cleanly on a sharp table edge or other edge in order to form folds in the box making material and to make boxes.

FIG. 4 shows a first embodiment of grid marked sheet material 40 of the invention with pairs of parallel, relatively widely spaced apart grid line sets 42a and 42b, which are perpendicular to pairs of parallel, relatively widely spaced apart grid line sets 44a and 44b. Each of the double line sets 42a and 42b, and 44a and 44b are made of two lines (e.g. by printing) of any thickness spaced 0.635 cm (¼ inch) from each other (for 0.317 cm, ⅛ inch thick cardboard.) For different thicknesses of cardboard, the spacing can be adjusted accordingly. For example, the left lines 42a in the sets are 2.54 cm (1 inch) apart and the right lines 42b in the sets are 2.54 cm (1 inch) apart. Likewise, the upper lines 44a in the sets 2.54 cm (1 inch) apart and the lower lines 44b in the sets are 2.54 cm (1 inch) apart. When making the larger tops of the boxes, the more widely spaced apart lines of double-line sets are used, namely a left side 42a line and a right side 42b side line, and a upper side 44a line and a lower side 44b line. When making the smaller bottoms of the boxes, the other line of the appropriate double-line sets are used, namely the more narrowly spaced apart sets of double-lines are used, a left side 42b line and a right side 42a line, and a upper side 44b line and a lower side 44a line. The appropriate lines are followed for cutting and folding the box sides and flaps. This enables any person to easily and quickly make a wide variety of boxes both with regard to design and to size with nothing more than a razor knife (or even scissors) and a rigid 90 degree edge over which to bend the cardboard. Tape, glue, adhesives, staples, or some other materials and/or means to attach the flaps to the sides are of course still needed. However, no measuring tools are needed to determine where to fold the boxes. The use of the printed double line sets makes the cardboard itself essentially serve the purpose of the box making kits covered in the inventor's previous patents, all of which provide for the automatic spacing of lines on which to cut and fold boxes, particularly for forming cardboard boxes.

The boxes are made essentially the same way as those boxes covered in the inventor's prior patents, by cutting and folding and gluing, except in the case of corrugated cardstock, the material is folded over the edge of a table with a sharp edge or over some other sharp edge. No pre-scoring is required. The cutting at the corners on the appropriate guide lines serve to exactly locate and facilitate the folding over the table edge or other sharp edge.

As shown in FIG. 5, for purposes of thinner materials such as cardstock, sheet material 50 has a series of double grid line sets 52a and 52b and 54a and 54b that are spaced more closely together (e.g. about 0.159 cm, 1/16 inch apart) than in the sheet material of FIG. 4 used on corrugated cardboard. With materials such as cardstock, in order to help ensure that the fold line is made very straight, in addition to a sharp edge of a table or other surface, a metal serrated edge, such as a hacksaw blade mounted to the edge of and extending slightly above the surface of a table or workbench will function well.

Turning now to FIG. 6, an embodiment of sheet material 60, such as corrugated cardboard, with a pattern of triple parallel line sets 62a, 62b, and 62c, and 64a, 64b, and 64c, in a grid pattern, is shown. Each of the triple line sets 62a, 62b, and 62c, and 64a, 64b, and 64c comprise printed lines of any thickness spaced 0.635 cm (¼ inch) from each other (for 0.318 cm, ⅛ inch thick cardboard.) For example, the left lines 62a, middle lines 62b, and right lines 62c in the triplet set are 2.54 cm (1 inch) apart from adjacent triplet set of lines 62a, 62b, and 62c, respectively. Likewise, the upper lines 64a, middle lines 64b, and lower lines 64c in the triplet set are 2.54 cm (1 inch) apart from adjacent triple set of lines 64a, 64b, and 64c, respectively.

Referring to FIG. 6, sheet material 60, such as corrugated cardboard, with a pattern of triple parallel line sets 62a, 62b, and 62c, and 64a, 64b, and 64c, in a grid pattern, is shown. Each of the triple line sets 62a, 62b, and 62c, and 64a, 64b, and 64c comprise printed lines of any thickness spaced 0.635 cm (¼ inch) from each other (for 0.318 cm, ⅛ inch thick cardboard.) For example, the left lines 62a, middle lines 62b, and right lines 62c in the triplet sets are 2.54 cm (1 inch) apart from adjacent triplet sets of lines 62a, 62b, and 62c, respectively. Likewise, the upper lines 64a, middle lines 64b, and lower lines 64c in the triplet set are 2.54 cm (1 inch) apart from adjacent triple set of lines 64a, 64b, and 64c, respectively.

In the embodiment of the sheet material 80 and 90 shown in FIGS. 7 and 8, respectively, additional marking indicia are applied to the grid designs. In sheet material 70 of FIG. 7, marking indicia 76 is placed at the intersections of some of triple parallel grid line 72b and 74b, of grid line sets 72a, 72b, and 72c, and 74a, 74b, and 74c. For example, marking indicia 76 can be spaced 15.24 cm (six inches) apart. Marking indicia 76 is shown, as a printed dot but can comprise any other shape, size, and color. Other spacings are also possible. In sheet material 80 of FIG. 8, the printed indicia comprising letters A, B and C are placed adjacent to at least some of the triple line sets 82a, 82b, and 82c, and 84a, 84b, and 84c. In the case of sheet material 80, the letters A, B, and C are placed at 7.62 cm (3 inch) intervals both horizontally and vertically.

The additional indicia 76 or A, B, C, can add a design element to the pattern, as well as help a person making a box with the sheet material easily identify the proper line to select for folding and cutting. Indeed, these added indicia 76 or A, B, C, can eliminate the need for tools for measuring the dimensions or counting out a large number of grid lines, and thus simplify the process.

The use of triple line set grid lined sheet material 60, 70 and 80 is basically the same as with respect to the double line grid designs 40 and 50, but allows a user to better select the outside and inside dimensions of the finished box. The middle lines 62b, 64b, 72b, 74b, and 82b and 84b are preferably additionally identified by having a different appearance, (e.g. dashed lines, different color, etc.) For example, in such a grid pattern, the middle lines are spaced apart in one inch increments.

In accordance with this example, to create a box having an external size of about 7.62 cm×7.62 cm×7.62 cm (3 inch×3 inch×3 inch), a user would first cut two blanks of cardstock nominally 9 inch×9 inch cutting the cardstock on the outside line of triple line sets which are nominally 9 inch apart. The user would then fold the smaller bottom of the box along the middle lines of the sets that are three grid units apart both widthwise and lengthwise and three grid units from each edge of the cardstock. To form the top of the box, the user would fold the sheet of material on outside lines of the triple grid sets that are three grid units apart both widthwise and lengthwise. Likewise, if a user wishes to form a box wherein the internal size is about 3 inch×3 inch×3 inch, the user will form the box top by folding the larger top of the box along the middle lines that are three grid units apart both widthwise and lengthwise. Then, to form the smaller bottom of the box, the user would fold the sheet of material on inside lines of the triple grid sets that are three grid units apart both widthwise and lengthwise. Greater versatility and control can thus be achieved with the triple line embodiment of the invention.

FIG. 9 is a plan view showing pre-scored sheet material 100 of the invention. In this pre-scored sheet material 100, a sheet of cardstock (e.g. 0.051 inch [0.02 cm] thick) has a grid pattern of horizontal and vertical scores 102 and 104 spaced apart by a predetermined interval “I” (e.g. in 2.54 cm [1 inch]). Each score 102 and 104 has two indented ridges 106a and 106b and 108a and 108b, respectively, at the longitudinal edges of the scores. The two indented ridges 106a and 106b and 108a and 108b of each respective score line 102 and 104 are spaced by a precise distance “S” and provide, in effect, a set of dual score lines. The predetermined interval “I” and precise distance “S” are better shown in FIG. 10. The scored cardstock 100 can be folded on either of the two parallel crease lines or two selected indented ridges, yielding nesting trays of two slightly different sizes.

Referring to FIG. 11, after the cardstock blank is cut to size (if necessary), in order to form a box top with a larger length “L” and width “W” (that is folded along the outer lying indented ridges), the user will preferably place indicator marks on the outer lying intersections 110 of indented ridges of the desired horizontal and vertical scores 102 and 104 (also shown in FIG. 10.) Thereafter, as shown in FIG. 12, the user will preferably make notch indicator marks 112 extending to edges 114 along the outer lying indented ridges 108a and 108b (or alternately 106a and 106b extending to edges 116, not shown), and preferably a second, angled lines 118 that also extends to edges 114 (or to edges 116, not shown.)

Turning to FIG. 13, the user will next cut along notch indicator marks 112 and angled lines 116 to form the notches 120 and form the notched sheet 122. After the notched sheet 120 is formed, the user will fold along ridges 106a and 106b and 108a and 108b that intersect with outer lying intersections 110. The notches 120 that extend to outer lying intersections 110 create inherent weaknesses, and the user can easily fold the notched sheet 122 at the desired outer lying indented ridges. The rectangular center 124 thus formed has a length L and width W. Tabs 126 are formed at the corners, and box sides 128 and 130 are formed (having height H.) A user can then easily fold up box sides 128 and 130 and affix flaps 126 to ends of sides walls 128 to form a completed box top.

As shown in FIG. 14, in order to form a box bottom 140 with a slightly small length L′ and width W′ than that of the box top of FIG. 13, the user will form notches 142 that extend from the intersection 144 of inner lying ridges 106b and 106a and 108b and 108a. The rectangular center 146 thus formed has a length L′ and width W′, where L=L′+2S, and W=W′+2S. The box sides 148 and 150 have a height H′ which is slightly larger than height H of box top. A user can then easily fold up box sides 148 and 150 and affix flaps 152 to ends of sides walls 148 to form a completed box bottom. The completed box bottom and box top will thus be capable of perfectly telescoping into each other. While it is not absolutely necessary, a user can help ensure that the box sheet material is folded at the desired indented ridges by bending the sheet material over a sharp edge (e.g. a sharp table edge.) These methods will work for small hand scoring as is done with the patents referred to herein as well as marking on corrugated cardstock either by hand or with the use of machinery of any size. It can be used on automatic box making equipment as well as automatic equipment that scores cardstock, including corrugated cardstock, for any purpose such as, but not limited to, displays, folders, packaging dunnage and other things made out of folded cardstock (the word cardstock as used here means any thin material, whether it is made of paper or plastic or metal.)

This above description is not intended to limit the invention to only the exact methods and configurations shown and described herein. Indeed, the invention will also work with any other product wherein two bending or folding lines are needed near each other for a mating fit or for clearance, not just boxes. Furthermore, the drawings showing the shapes of the double mark score and the tools needed are not intended to limit this invention to only that shape and those tools.

1. A device for forming score lines in sheet material, comprising:
a scoring plate having an upper surface with an elongate groove formed therein, the elongate groove having two edges and having a groove width; and
a scoring tool having a working head, the working head having a width that is greater than that of the elongate groove.

2. The device for forming score lines in sheet material of claim 1, wherein the two inner edges are sharp.

3. The device for forming score lines in sheet material of claim 1, further comprising a plurality of guide indicia on the upper surface of the scoring plate.

4. The device for forming score lines in sheet material of claim 3, wherein the guide indicia comprise a plurality of parallel line sets formed on the scoring plate, the plurality of parallel lines being parallel to the elongate groove.

5. The device for forming score lines in sheet material of claim 1, wherein the working head of the scoring tool is smooth.
